(19) United States
(12) Patent Application Publication
(10) Pub. No.: US 2014/0258759 A1
(43) Pub. Date: Sep. 11, 2014

(54) SYSTEM AND METHOD FOR DE-QUEUING AN ACTIVE QUEUE

(71) Applicant: LSI CORPORATION, San Jose, CA (US)

(72) Inventors: Deepak Mital, Orefield, PA (US); William Burroughs, Macungie, PA (US)

(73) Assignee: LSI Corporation, San Jose, CA (US)

(21) Appl. No.: 13/795,350

(22) Filed: Mar. 12, 2013

Related U.S. Application Data
(60) Provisional application No. 61/773,412, filed on Mar. 6, 2013.

(51) Int. Cl. G06F 1/32; G06F 9/48

(52) U.S. Cl. CPC G06F 1/3287; G06F 9/4893
USPC 713/324; 718/102

(57) ABSTRACT

Aspects of the disclosure pertain to a system and method for de-queuing an active queue. The system promotes power efficiency by providing a mechanism for allowing some of its active queues to be de-queued and one or more of its processors associated with those active queues to be powered off during low traffic periods. Using fewer than all of its queues and processors, the system can handle incoming traffic during these low traffic periods without packet loss and without ordering issues.

### CROSS-REFERENCE TO RELATED APPLICATIONS

This application claims priority to U.S. Provisional Application No. 61/773,412 filed on Mar. 6, 2013, entitled: “A System and Method for De-queuing an Active Queue”, which is hereby incorporated by reference in its entirety.

### FIELD OF THE INVENTION

The present disclosure relates to the field of networking systems and particularly to a system and method for de-queuing an active queue.

### BACKGROUND

Networking systems are interconnected by communication channels that allow for sharing of resources and information. However, networking systems are often not power efficient.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter in any manner

Aspects of the disclosure pertain to a system and method for de-queuing an active queue.

### BRIEF DESCRIPTION OF THE FIGURES

The detailed description is described with reference to the accompanying figures:

FIG. 1 is an example conceptual block diagram schematic of a networking system in accordance with an exemplary embodiment of the present disclosure; and

FIG. 2 is a flow chart illustrating a method of operation of the networking system shown in FIG. 1, in accordance with an exemplary embodiment of the present disclosure.

### WRITTEN DESCRIPTION

Embodiments of the invention will become apparent with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. Among other things, the features of the disclosure can be facilitated by methods, devices, and/or embodied in articles of commerce. The following detailed description is, therefore, not to be taken in a limiting sense.

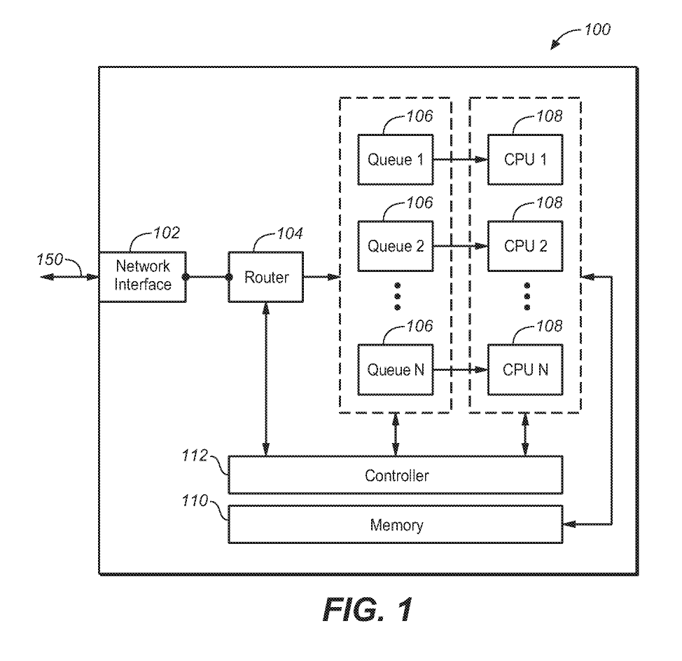

Referring to FIG. 1 (FIG. 1), a system 100 is shown. In embodiments, the system 100 is a module (e.g., a node, a device). In embodiments, the system 100 is a computer. In embodiments, the system 100 is a networking system which is configured for being connected to (e.g., communicatively coupled with) one or more other systems (e.g., modules) 100 via an interconnect (e.g., a bus, communication channels) 150 to form a network. In embodiments, the system 100 is configured for sharing resources and information with (e.g., receiving data from and sending data to) the other systems of the network.

In embodiments, the system 100 includes a network interface (e.g., a network interface controller, a network interface card, a network adapter card, a local area network (LAN) adapter) 102. In embodiments, the network interface 102 is a computer hardware component for connecting the system 100 to the network. In embodiments, the system 100 is configured for receiving data from and transmitting data to the other systems of the network via the network interface 102.

As mentioned above, the system 100 is configured for being connected to one or more other systems to form a network. In embodiments, the network is a packet mode computer network, such that the system 100 is configured for transmitting data to and receiving data from other systems of the network in the form of packets. For example, the packets are formatted units of data carried by the packet mode computer network. In embodiments, the packets include control information and user data (e.g., payload). For example, the control information provides (e.g., includes) data the network needs to deliver the user data, such as source addresses, destination addresses, etc. The control information is found in packet headers and trailers with the user data (e.g., payload) being located between the packet headers and trailers.

In embodiments, the network interface 102 is configured for receiving packets (e.g., data) from other system(s) of the network. In embodiments, the packets include (e.g., contain) tasks. In embodiments, tasks are data structures used for communication between the system 100 and other systems of the network. In embodiments, tasks carry all of the necessary data for allowing the system 100 to process commands contained within the tasks. In embodiments, tasks carry pointers. For example, a pointer is a programming language data type whose value refers directly to (e.g., points to) another value stored elsewhere in the system 100 using its address.

In embodiments, the system 100 includes a router 104. In embodiments, the router 104 is connected to (e.g., communicatively coupled with) the network interface 102. In embodiments, the network interface 102 is configured for transmitting the data it receives from the other system(s) of the network to the router 104.

In embodiments, the system 100 includes a plurality of queues (e.g., task queues) 106. In embodiments, the queues 106 are connected to (e.g., communicatively coupled with) the router 104. In embodiments, the queues 106 are input queues. In embodiments, the queues 106 are implemented in hardware.

In embodiments, the router 104 is configured for receiving the data transmitted to it by the network interface 102. In embodiments, the router 104 is configured for transmitting (e.g., forwarding) tasks included in the received data to the queues 106. In embodiments, the router 104 is configured for selectively transmitting the tasks to the queues 106, as will be explained further below.

In embodiments, the queues 106 are configured for receiving (e.g., collecting, holding) the tasks transmitted to them by the router 104. In embodiments, the queues 106 are configured for processing the collected tasks. For example, the queues 104 are configured for transmitting (e.g., feeding) the collected tasks to a plurality of processors 108 of the system 100. In embodiments, the processors 108 are connected to (e.g., communicatively coupled with) the queues 106.

In one or more embodiments, the processors 108 are engines, processing engines, and/or central processing units (CPUs)). In embodiments in which the processors 108 are CPUs, the processors 108 are hardware that is configured for carrying out the instructions of computer programs by performing basic operations of the system 100. In embodiments, the processors 108 are configured for receiving the tasks transmitted by the queues 106 and processing (e.g., working on) the tasks. For example, the processors 108 are configured for writing the tasks to a memory 110 of the system 100. In embodiments, the memory 110 is communicatively coupled with the processors 108. In embodiments, the memory 110 includes one or more physical devices used to store programs (e.g., sequences of instructions) or data (e.g., program state information) on a temporary or permanent basis for use in the system 100. For example, the memory 110 can include random-access memory (RAM).

In embodiments, each queue 106 can be allocated to its own corresponding processor 108 included in the plurality of processors. For example, the system 100 can include eight processors 108 and eight queues 106, wherein a one-to-one correspondence is established between the processors 108 and queues 106, such that the first queue provides tasks only to the first processor, the second queue provides tasks only to the second processor, and so forth. In other embodiments, the number of queues 102 and processors 104 of the system can vary from what is described above. In other further embodiments, the number of queues 102 allocated to a particular processor 104 can vary from the one-to-one correspondence model described above.

In embodiments, the system 100 includes a controller 112. In embodiments, the controller 112 is connected to (e.g., communicatively coupled with) the router 104. In embodiments, the controller 112 is connected to the processors 108. In embodiments, the controller 112 is connected to the queues 106. In embodiments, the controller 112 is configured for transmitting signals to and receiving signals from the router 104, the processors 108 and/or the queues 106. In one or more embodiments, the controller 112 is one of the processors 108.

Under some circumstances, the amount of traffic (e.g., data, packets, tasks) received by the system 100 may be relatively low, such that the processors 108 of the system 100 are under-utilized. In such circumstances, the system 100 described herein is configured for handling (e.g., processing) all of the traffic received, even if utilizing fewer than all of the queues 106 and processors 108 of system 100. For example, as will be discussed in detail below, the system 100 is configured for handling (e.g., processing) all incoming traffic while having one or more queues 106 de-activated (e.g., de-queued, inactivated) and one or more processors 108 powered off, without experiencing a loss of packets and/or any ordering issues (e.g., order of the packets is maintained). By having such capabilities, the system 100 promotes power efficiency in that underutilized queues 106 and processors 108 can be powered off during low traffic periods.

In embodiments, the controller 112 of the system 100 is configured for activating (e.g., placing) a processing stop on a first set of queues included in the plurality of queues 106. For example, the first set of queues 106 includes one or more (but not all) of the queues included in the plurality of queues. In embodiments, the processing stop prevents the first set of queues 106 and a first set of processors 108 corresponding to (e.g., connected to) the first set of queues 106 from processing tasks. The first set of processors 108 includes one or more (but not all) of the processors included in the plurality of processors. In embodiments, the processing stop may be activated when the system 100 determines that the system 100 is in a low traffic period. For example, a low traffic period may be a period during which all incoming traffic to the system 100 can be processed utilizing fewer than all of the queues 106 and processors 108 of the system 100. In embodiments, the controller 112 may be configured for detecting when the system 100 is in a low traffic period and providing signals to the first set of queues and first set of processors 108 for activating the processing stop.

In embodiments, when the processing stop is in effect, the first set of queues 106 is prevented from transmitting tasks to the first set of processors 108. Further, when the processing stop is in effect, the first set of queues 106 is configured for receiving (e.g., accumulating) all tasks (e.g., input tasks) which are received by the system 100 while the processing stop is in effect. In embodiments, the queues 106 of the system 100 are configured for holding a large number of input tasks (e.g., an amount of input tasks consistent with what would typically be received during high traffic conditions for the system).

In embodiments, for any tasks received by the system 100 while the processing stop is in effect, the router 104 of the system 100 is configured for directing all of those tasks to the first set of queues 106 and to steer them away from the remaining queue(s) (e.g., the second set of queues) included in the plurality of queues 106. For example, the controller 112 may be configured for providing a signal to the router 104 to cause the router 104 to direct tasks to the queues 106 in the above-referenced manner. As mentioned above, the first set of queues 106 receives and accumulates (e.g., stores) these tasks, but does not forward them to the first set of processors 108, thus these tasks are not processed.

In embodiments, while the processing stop is in effect upon the first set of queues 106, any tasks which were contained by the second set of queues at the time the processing stop was placed upon the first set of queues 106 are transmitted to a second set of processors corresponding to (e.g., connected to) the second set of queues where the tasks are processed. For example, the second set of processors includes the remaining processor(s) of the plurality of processors 108 (e.g., the processors of the plurality of processors which are not part of the first set of processors). In embodiments, processing by the second set of queues 106 and second set of processors 108 occurs until each queue included in the second set of queues 106 is empty. In embodiments, the system 100 may include a mechanism for increasing processing speeds of the processors 108 included in the second set of processors for promoting expedited emptying of the queues 106 included in the second set of queues. In embodiments, when processing of these tasks by the second set of processors is complete and no tasks are present in the second set of queues, the following events occur: the second set of queues is de-queued (e.g., taken offline, de-activated, inactivated, powered off), all processor(s) included in the second set of processors 108 is/are powered off, and the processing stop on the first set of queues is de-activated (e.g., removed). In embodiments, the controller 112 may be configured for providing one or more signals to the queues 106 and/or the processors 108 for causing de-queuing of the queues 106, powering off of the second set of processors 108 and/or de-activation of the processing stop on the first set of queues.

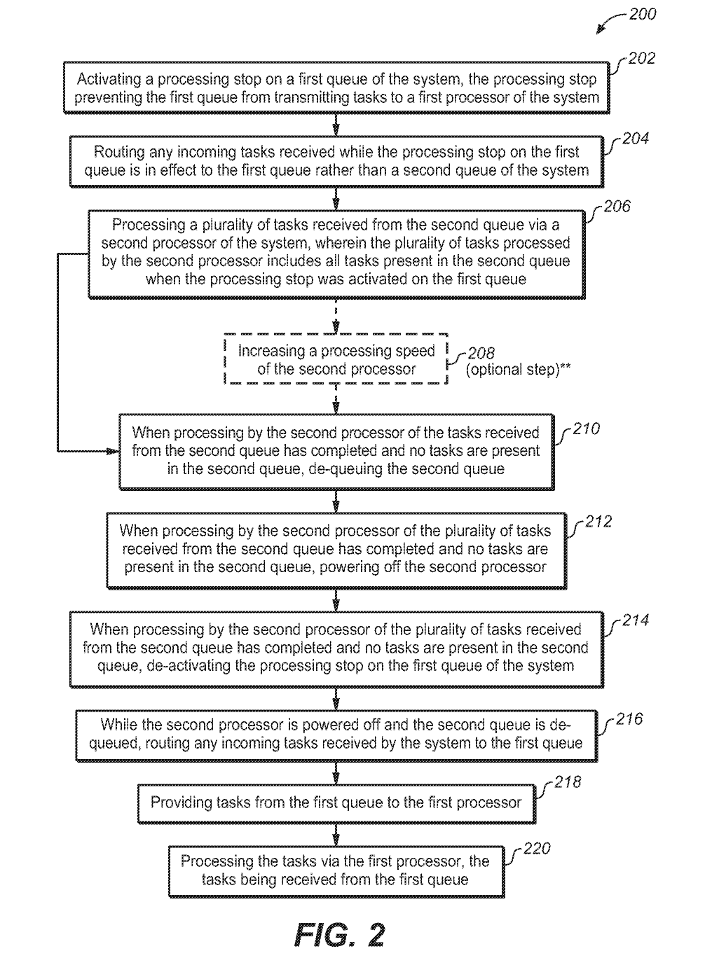

FIG. 2 (FIG. 2) is a flowchart illustrating a method of operation of the system 100 described above. In embodiments, the method 200 includes a step of activating (e.g., placing) a processing stop on a first queue of the system, the processing stop preventing the first queue from transmitting tasks to a first processor of the system (Step 202). In embodiments, the method 200 includes a step of routing any incoming tasks received while the processing stop on the first queue is in effect to the first queue rather than a second queue of the system (Step 204). In embodiments, the method 200 includes a step of processing a plurality of tasks received from the second queue via a second processor of the system, wherein the plurality of tasks processed by the second processor includes all tasks present in the second queue when the processing stop was activated on the first queue (Step 206). In some embodiments, the method 200 may include a step of increasing a processing speed of the second processor (Step 208).

In embodiments, the method 200 includes a step of, when processing by the second processor of the plurality of tasks received from the second queue has completed and/or when no tasks are present in the second queue, de-queuing the second queue (Step 210). In embodiments, the method 200 includes a step of, when processing by the second processor of the plurality of tasks received from the second queue has completed and/or when the second queue is empty, powering off the second processor (Step 212). In embodiments, the method 200 includes a step of when processing by the second processor of the plurality of tasks received from the second queue has completed and/or when the second queue is empty, de-activating the processing stop on (e.g., removing the processing stop from) the first queue of the system (Step 214).

In embodiments, the method 200 includes a step of, while the second processor is powered off and while the second queue is de-queued, routing any incoming tasks received by the system to the first queue (Step 216). In embodiments, the method 200 includes a step of providing tasks from the first queue to the first processor (Step 218). In embodiments, the method 200 includes a step of processing the tasks via the first processor, the tasks being received from the first queue (Step 220).

It is to be noted that the foregoing described embodiments may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the embodiments described herein may be conveniently implemented in forms of a software package. Such a software package may be a computer program product which employs a non-transitory computer-readable storage medium including stored computer code which is used to program a computer to perform the disclosed functions and processes disclosed herein. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of operation of a system, the method comprising:
activating a processing stop on a first queue of the system, the processing stop preventing the first queue from transmitting tasks to a first processor of the system;
routing any incoming tasks received while the processing stop on the first queue is in effect to the first queue rather than a second queue of the system;
processing a plurality of tasks received from the second queue via a second processor of the system, wherein the plurality of tasks processed by the second processor includes all tasks present in the second queue when the processing stop was activated on the first queue.

2. The method as claimed in claim 1, further comprising:
when processing by the second processor of the plurality of tasks received from the second queue has completed and no tasks are present in the second queue, de-queuing the second queue.

3. The method as claimed in claim 2, further comprising:
when processing by the second processor of the plurality of tasks received from the second queue has completed and no tasks are present in the second queue, powering off the second processor.

4. The method as claimed in claim 3, further comprising:
when processing by the second processor of the plurality of tasks received from the second queue has completed and no tasks are present in the second queue, de-activating the processing stop on the first queue of the system.

5. The method as claimed in claim 4, further comprising:
while the second processor is powered off and the second queue is de-queued, routing any incoming tasks received by the system to the first queue.

6. The method as claimed in claim 5, further comprising:
providing tasks from the first queue to the first processor.

7. The method as claimed in claim 6, further comprising:
processing the tasks via the first processor, the tasks being received from the first queue.

8. The method as claimed in claim 1, further comprising:
increasing a processing speed of the second processor.

9. A non-transitory computer-readable medium having computer-executable instructions for performing a method of operation of a system, the method comprising:
activating a processing stop on a first queue of the system, the processing stop preventing the first queue from transmitting tasks to a first processor of the system;
routing any incoming tasks received while the processing stop on the first queue is in effect to the first queue rather than a second queue of the system;
processing a plurality of tasks received from the second queue via a second processor of the system, wherein the plurality of tasks processed by the second processor includes all tasks present in the second queue when the processing stop was activated on the first queue; and
when processing by the second processor of the plurality of tasks received from the second queue has completed and no tasks are present in the second queue, de-queuing the second queue.

10. The non-transitory computer-readable medium as claimed in claim 9, the method further comprising:
when processing by the second processor of the plurality of tasks received from the second queue has completed and no tasks are present in the second queue, powering off the second processor.

11. The non-transitory computer-readable medium as claimed in claim 10, the method further comprising:
when processing by the second processor of the plurality of tasks received from the second queue has completed and no tasks are present in the second queue, de-activating the processing stop on the first queue of the system.

12. The non-transitory computer-readable medium as claimed in claim 11, the method further comprising:
while the second processor is powered off and the second queue is de-queued, routing any incoming tasks received by the system to the first queue.

13. The non-transitory computer-readable medium as claimed in claim 12, the method further comprising:
providing tasks from the first queue to the first processor.

14. The non-transitory computer-readable medium as claimed in claim 13, the method further comprising:
processing the tasks via the first processor, the tasks being received from the first queue.

15. The non-transitory computer-readable medium as claimed in claim 9, the method further comprising:
increasing a processing speed of the second processor.

16. A system, comprising:
a plurality of processors, the plurality of processors configured for processing input tasks received by the system;
a plurality of queues, the plurality of queues being connected to the plurality of processors, the plurality of queues configured for receiving the input tasks and transmitting the input tasks to the plurality of processors;
a router, the router being connected to the plurality of queues, the router configured for directing the input tasks to the plurality of queues; and
a controller, the controller being connected to the router, the plurality of processors and the plurality of queues,
wherein the controller activates a processing stop for preventing a first queue included in the plurality of queues from transmitting input tasks to a first processor included in the plurality of processors while the processing stop is in effect.

17. The system as claimed in claim 16, wherein the router directs any incoming tasks received while the processing stop is in effect to the first queue and away from a second queue included in the plurality of queues.

18. The system as claimed in claim 17, wherein a second processor included in the plurality of processors receives and processes all input tasks which were present in the second queue when the processing stop was activated.

19. The system as claimed in claim 18, wherein the system de-queues the second queue when processing of all of the input tasks present in the second queue when the processing step was activated is completed.

20. The system as claimed in claim 19, wherein the system powers off the second processor when processing of all of the input tasks present in the second queue when the processing step was activated is completed.
